(19) United States
(12) Patent Application Publication
(10) Pub. No.: US 2023/0127273 A1
(43) Pub. Date: Apr. 27, 2023

(54) METHOD AND SYSTEM FOR SELLING PERSONAL CONTENT USING VALUE EVALUATION

(71) Applicant: PIXTREE CO., LTD., Seoul (KR)

(72) Inventors: Jaeseob SHIN, Seoul (KR); Sungul RYOO, Seoul (KR); Sehoon SON, Seoul (KR); Yeonbae KIM, Seoul (KR)

(21) Appl. No.: 18/086,632

(22) Filed: Dec. 21, 2022

Related U.S. Application Data
(63) Continuation-in-part of application No. PCT/KR2021/007707, filed on Jun. 21, 2021.

(30) Foreign Application Priority Data
Jun. 23, 2020 (KR) 10-2020-0076599

(51) Int. Cl. G06Q 50/18; G06T 5/20; G06T 7/00

(52) U.S. Cl. CPC G06Q 50/184; G06T 5/20; G06T 7/0002; G06T 2207/30168

(57) ABSTRACT

Disclosed are a method and a system for selling personal content using value evaluation, capable of improving image quality of content produced in a terminal by an external server, outputting a result of comparison with a local image quality improvement result generated in the terminal, proposing a profit model and profit sharing together with a value evaluation result for the content in transmitting the external image quality improvement result for the content to the terminal, and distributing the content according to a consent to the proposal to create a profit.

### TECHNICAL FIELD

An embodiment of the present disclosure relates to a method and a system for selling personal content using value evaluation.

### BACKGROUND ART

The following description merely provides background information related to the present inventive concept, and does not constitute the prior art.

As smart phones and tablet computers become popular, the importance of content including applications used in such devices is increasing. In addition, the importance of content is increasing not only in portable terminals but also in general personal computer (PC) environments.

Content for smart phones and tablet computers may be installed on the devices in various ways, but a lot of users use a method of accessing a market where content is uploaded, searching for the content, and downloading and installing the content.

A general content market system provides a method of directly uploading personal content (videos, photos, sound sources, or the like) produced by users onto a corresponding content market, and distributing a price for consumption or an advertisement profit in distributing a price for consumption or an advertisement profit in a case where the content is consumed.

However, from the viewpoint of the users that produced the personal content, there is an inconvenience in the users have to upload the personal content onto various markets suitable for each purpose, and there is a problem in that there is little profit to be distributed in a case where the personal content is not exposed.

### DISCLOSURE

### Technical Problem

An object of the present inventive concept is to provide a method and a system for selling personal content using value evaluation, capable of improving image quality of content produced in a terminal by an external server, outputting a result of comparison with a local image quality improvement result generated in the terminal, proposing a profit model and profit sharing together with a value evaluation result for the content in transmitting the external image quality improvement result for the content to the terminal, and distributing the content according to a consent to the proposal to create a profit.

### Technical Solution

According to an aspect of the present embodiment, there is provided a system for selling personal content using value evaluation, including: a user terminal that performs an internal image quality improvement process for selected personal content to generate a local image quality improvement result, receives an external image quality improvement result for the personal content, compares the local image quality improvement result with the external image quality improvement result for the personal content, and outputs the comparison result; and a cloud server that receives the personal content, performs an external image quality improvement process for the personal content to generate the external image quality improvement result, transmits the external image quality improvement result to the user terminal, proposes a business right together with a value evaluation result obtained by valuating the personal content for which the external image quality improvement has been performed, distributes the personal content for which the external image quality improvement has been performed in a case where a consent to the business right is made from the user terminal, and shares a profit for the personal content.

According to another aspect of the present embodiment, there is provided a method for selling personal content using value evaluation, including: performing an internal image quality improvement process for selected personal content to generate a local image quality improvement result, by a user terminal; receiving the personal content, performing an external image quality improvement process to generate an external image quality improvement result, and transmitting the result to the user terminal, by a cloud server; receiving the external image quality improvement result for the personal content, by the user terminal; comparing the local image quality improvement result with the external image quality improvement result for the personal content, and outputting the comparison result, by the user terminal; proposing a business right together with a value evaluation result obtained by performing value evaluation for the personal content for which the external image quality improvement has been performed, by the cloud server; distributing the personal content for which the external image quality improvement has been performed in a case where a consent to the business right is made from the user terminal, by the cloud server; and sharing a profit for the personal content, by the cloud server.

### Advantageous Effects

As described above, according to the embodiment of the invention, it is possible to improve image quality of content produced in a terminal by an external server, output a result of comparison with a local image quality improvement result generated in the terminal, propose a profit model and profit sharing together with a value evaluation result for the content in transmitting the external image quality improvement result for the content to the terminal, and distribute the content according to a consent to the proposal to create a profit.

### DESCRIPTION OF DRAWINGS

FIG. 1 is a diagram illustrating a system for selling personal content using value evaluation according to an exemplary embodiment of the invention.

FIG. 2 is a diagram illustrating an example of comparison of a local image quality improvement result and an external image quality improvement result according to an exemplary embodiment of the invention.

FIG. 3 is a diagram illustrating a method for selling personal content using value evaluation according to an exemplary embodiment of the invention.

### DESCRIPTION OF REFERENCE NUMERALS

110: User terminal

112: Application

120: Cloud server

130: Data interface server

140: External image quality improvement engine

150: Value evaluation engine

160: Blockchain generating engine

170: Business management server

180: Project evaluation server

190: Distribution server

### DETAILED DESCRIPTION

Hereinafter, exemplary embodiments will be described in detail with reference to the accompanying drawings.

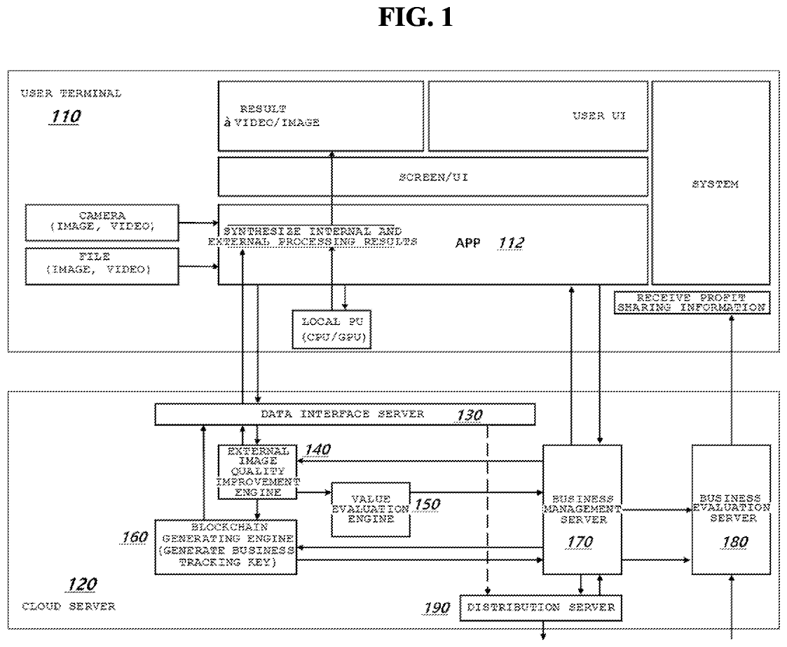

FIG. 1 is a diagram illustrating a system for selling personal content using value evaluation according to an exemplary embodiment of the invention.

The system according to the present embodiment includes a user terminal 110, an application 112, a cloud server 120, a data interface server 130, an external image quality improvement engine 140, a value evaluation engine 150, a Blockchain generating engine 160, a business management server 170, a business evaluation server 180, and a distribution server 190. Components included in the present system are not necessarily limited thereto.

The user terminal 110 refers to an electronic device that performs voice or data communication via a network according to user's key manipulation. The user terminal 110 includes a memory for storing a program or protocol for communication with the cloud server 120 via the network, a microprocessor for execution the corresponding program for calculation and control, and the like. The user terminal 110 may be an electronic device such as a smart phone, a tablet, a laptop, a personal digital assistant (PDA), a portable multimedia player (PMP), a wireless communication terminal, or a media player.

The user terminal 110 may be provided as a variety of devices provided with (i) a communication device such as a communication modem for communicating with various devices or wired/wireless networks, (ii) a memory for storing various programs and data, and (iii) a microprocessor for executing programs for calculation and control. According to at least one embodiment, the memory may be a computer-readable recording/storage medium such as a random access memory (RAM), a read only memory (ROM), a flash memory, an optical disc, a magnetic disc, or solid state disk (SSD). According to at least one embodiment, the microprocessor may be programmed to selectively perform one or more of operations and functions described herein. According to at least one embodiment, the microprocessor may be wholly or partially configured as hardware such as an application specific integrated circuit (ASIC).

The user terminal 110 includes an application 112. The application 112 refers to a program that is loaded and driven in the memory of the user terminal 110. The application 112 may be loaded in the form of being embedded in the user terminal 110 or in the form of being installed in an operating system (OS).

In a case where a video or image is captured using the user terminal 110, since a digital zoom function is applied, a degraded image quality is obtained. The user terminal 110 performs local processing (using its own CPU/GPU) on the video or image of the degraded image quality to generate a local image quality improvement result.

The user terminal 110 transmits the video or image of the degraded image quality to the cloud server 120, and then receives an external image quality improvement result obtained by improving the image quality using external processing (using the external image quality improvement engine 140) from the cloud server 120.

The user terminal 110 synthesizes the local image quality improvement result and the external image quality improvement result, and outputs the result. The user terminal 110 may output the local image quality improvement result and the external image quality improvement result half and half, or may output the external image quality improvement result only for a part of an object in the image (for example, a face area) and may output the local image quality improvement result for the remaining area. Here, the user terminal 110 may adjust internal options so that the external image quality improvement result is not output.

In order to download the external image quality improvement result for the whole area from the image in which the local image quality improvement result and the external image quality improvement result are combined, the user terminal 110 pays for the cost of the external image quality improvement result for the whole area to the cloud server 120, and then downloads the external image quality improvement result for the whole area from the cloud server 120.

The user terminal 110 outputs the local image quality improvement result and the external image quality improvement result so that the user can compare them using the loaded application 112. In outputting a screen for comparing the local image quality improvement result with the external image quality improvement result, the user terminal 110 outputs the screen for comparison using various methods such as a left-right comparison method, a top-bottom comparison method, a random area comparison method, a main (external)/sub (internal) area comparison method, and a sequential comparison method.

The user terminal 110 performs an internal image quality improvement process on selected personal content to generate a local image quality improvement result. The user terminal 110 receives an external image quality improvement result for the personal content from the cloud server 120. The user terminal 110 compares the local image quality improvement result with the external image quality improvement result for the personal content, and outputs the comparison result.

The user terminal 110 outputs the local image quality improvement result on one side of a screen, and outputs the external image quality improvement result on the other side of the screen to compare the local image quality improvement result with the external image quality improvement result. The user terminal 110 outputs the external image quality improvement result on a partial area of the screen, outputs the local image quality improvement result on the remaining area of the screen to compare the local image quality improvement result with the external image quality improvement result.

In outputting the screen for comparing the local image quality improvement result with the external image quality improvement result, the user terminal 110 outputs the screen for comparison using any one of the left-right comparison method, the top-bottom comparison method, the random area comparison method, the main (external)/sub (internal) area comparison method, and the sequential comparison method.

In order to download the entirety of the external image quality improvement result, the user terminal 110 pays for the cost of the external image quality improvement result to the cloud server 120, and then downloads the external image quality improvement result from the cloud server 120.

The user terminal 110 performs the internal image quality improvement process on the selected personal content (content captured from a camera or pre-stored content) on the basis of a local CPU or GPU using the loaded application 112 to generate the local image quality improvement result.

The application 112 included in the user terminal 110 receives business request information from the business management server 170. The application 112 included in the user terminal 110 outputs the business request information, and receives a response (consent) to the business request information from the user. The application 112 included in the user terminal 110 transmits information on the business response (consent) corresponding to the business request information to the business management server 170.

The user terminal 110 outputs the business right request received from the business management server 170 using the installed application 112, receives the consent corresponding to the business right request from the user, and transmits the consent to the business management server 170.

The cloud server 120 includes the same hardware modules as in a common web server or a network server in terms of hardware. The cloud server 120 may be implemented in the form of a web server or a network server. The cloud server 120 generally communicates with an unspecified number of clients via an open computer network such as the Internet. The cloud server 120 refers to a computer system and computer software (web server program) that derives and provides work results corresponding to work execution requests from clients or other web servers.

The cloud server 120 performs value evaluation for content on the basis of a result of artificial intelligence learning for the external image quality improvement result to generate a value evaluation result (calculation of expected profit and cost for a specific period of time). For example, the cloud server 120 may perform value evaluation on the basis of a result of artificial intelligence learning for tourist destination images (external image quality improvement result) to generate a value evaluation result of calculating the cost to earn 500,000 won for three months.

The cloud server 120 may perform value evaluation on the basis of a result of artificial intelligence learning for celebrity images (external image quality improvement result) to generate a value evaluation result of calculating the cost to earn 1 million won for a week.

The cloud server 120 requests a business right on the basis of the value evaluation result for the content of the user terminal 110 that produced the content or an application that is operated by a user account that produced the content. In other words, the cloud server 120 proposes a business request for a specific business (proposal of expected profit and cost for a specific period of time and a profit sharing ratio) while transmitting the external image quality improvement result and the value evaluation result to the user terminal 110.

In receiving a consent for the business request for the specific business from the user terminal 110, the cloud server 120 performs appropriate processing for corresponding content for business management and data protection, and then distributes the content. There may be various techniques for commercializing and distributing the content for which the business consent has been made, and

Blockchain is one example thereof. As another example, the processing may be performed using a combination of CAS and DRM, and such content may be directly uploaded to OTT services or other OTT services, for example. In the case of Blockchain, there is an advantage in that the content can be distributed without directly managing a separate OTT. That is, in a case where an advertisement is inserted into the content for which the business right has been secured and Blockchain is created and distributed, it is possible to recognize the content, to check a content consumption history or the like through Blockchain, and on the basis of such information, it is possible to receive advertising fees from advertisers to make a profit.

As an example of the present embodiment, Blockchain is applied to the content for distribution. The cloud server 120 identifies the profit for the content, and shares the result with the user terminal 110.

The cloud server 120 receives personal content from the user terminal 110, performs an external image quality improvement process for the personal content to generate an external image quality improvement result, and transmits the result to the user terminal 110. The cloud server 120 proposes a business right (profit model and profit sharing) together with a value evaluation result obtained by valuating the personal content for which the external image quality has been improved to the user terminal 110. In a case where the consent to the business right is given from the user terminal 110, the cloud server 120 applies Blockchain to the personal content for which the external image quality improvement has been performed, distributes the personal content, and shares the profit for the personal content to which Blockchain is applied.

The cloud server 120 includes the data interface server 130, the external image quality improvement engine 140, the value evaluation engine 150, the Blockchain generating engine 160, the business management server 170, the business evaluation server 180, and the distribution server 190.

The data interface server 130 interworks with the user terminal 110, and transmits the personal content received from the user terminal 110 to the external image quality improvement engine 140.

The external image quality improvement engine 140 transmits the external image quality improvement result to the value evaluation engine 150 as an input. The external image quality improvement engine 140 performs the external image quality improvement process for the personal content using an algorithm for image quality improvement such as upscaling, color correction, noise removal, and the like, using a pre-learned improvement model, to generate the external image quality improvement result.

The value evaluation engine 150 applies a result obtained by learning a business performance result related to at least one of a type, a quality, a subject, and a specification of the existing business progressing content to the engine. The value evaluation engine 150 outputs information about an expected profit, a period of time, and the like for each piece of content. The value evaluation engine 150 updates the engine by accumulating and continuously learning business performance of content for a newly applied business. The value evaluation engine 150 may apply a different engine to each type of content for management.

The value evaluation engine 150 performs business value evaluation. The value evaluation result generated by the value evaluation engine 150 is transmitted to the business management server 170, and then, the business management server 170 transmits business request information to the user terminal 110 on the basis of the value evaluation result.

The value evaluation engine 150 receives the external image quality improvement result for the personal content from the external image quality improvement engine 140, and performs value evaluation for the personal content to generate a value evaluation result including expected profit and cost for a specific period of time.

The value evaluation engine 150 performs value evaluation for the personal content on the basis of a learning result obtained by learning a business performance result related to at least one of a type, a quality, a subject, and a specification of the personal content to generate the value evaluation result including the expected profit and cost for the specific period of time. The value evaluation engine 150 transmits the value evaluation result for the personal content to the business management server 170.

The Blockchain generating engine 160 has a structure for updating blocks between duplicated entities of the same content in real time. The Blockchain generating engine 160 configures one Blockchain dimension for the same content (entire identical content that are duplicated and distributed) . At the moment when business target content is newly duplicated, the Blockchain generating engine 160 manages Blockchain in a structure in which the business target content is configured and connected as one block.

The Blockchain generating engine 160 receives the personal content for which the external image quality improvement has been performed from the business management server 170, generates a business tracking key as a block, inserts the result into the personal content for which the external image quality improvement has been performed, and transmits the personal content into which the block is inserted to the business management server. Instead of the method of receiving and processing the entire personal content from the Blockchain generating engine 160, a different method of receiving minimum personal content information necessary for Blockchain information generation to generate Blockchain information, and transmitting only the generated information to the business management server may be used.

The business management server 170 transmits the personal content including the block received from the Blockchain generating engine 160 to the distribution server 190. Alternatively, as in the above-described different method, in a case where only the Blockchain generation information is received, the block may be inserted into the business target content at this stage, or may be transmitted to the distribution server to then be inserted into the corresponding personal content in the distribution server. The distribution server 190 continuously updates the distribution and consumption content of the business target content to the Blockchain generating engine 160.

The business management server 170 generates commercialization information on the basis of the value evaluation result received from the value evaluation engine 150. In a case where the business management server 170 receives business response (consent) information corresponding to the business request information from the user terminal 110, the business management server 170 determines whether to proceed with the business.

The business management server 170 proposes a business right request including the expected profit and cost for the specific period of time and a profit sharing ratio for the personal content, while transmitting the external image quality improvement result for the personal content and the value evaluation result to the user terminal 110 that produced the content or an application that is operated by a corresponding user account.

The business management server 170 determines whether or not to proceed with the business right for the personal content for which the external image quality improvement has been performed in accordance with the consent corresponding to the business right request received from the user terminal 110, and transmits the result to the Blockchain generating engine 160.

The business management server 170 transmits content distribution reporting information for the block-inserted personal content received from the distribution server 190 to the business evaluation server 180. The business evaluation server 180 calculates profit information on the basis of the content distribution reporting information, and calculates business evaluation information on the basis of the profit information. The business management server 170 controls processing of information generated by the business evaluation server 180, such as the profit information and the business evaluation information.

The business evaluation server 180 checks distribution and consumption details by periodically checking the Blockchain information of the business target content under distribution. The business evaluation server 180 evaluates and creates an advertisement profit using the distribution and consumption details, and distributes the advertisement profit to business participating partners. The business participating partners include content providers, platform operators, and system providers.

In generating and distributing the business target content, the business evaluation server 180 checks whether or not a profit can be created by applying various methods such as a profit source addition method such as advertisement insertion or a fee-based method for content consumption alone or in combination.

The business evaluation server 180 generates business performance using Blockchain information on content or information of a management server according to a cumulative management method of the progress of the content business and a business progress history.

The business evaluation server 180 calculates the profit on the basis of the generated business performance, requests the profit of business-related business partners (advertisers, fee receivers, or the like), and notifies the related business partners (content providers, platform service participators/providers, or the like) of the profit secured as a distribution profit, and distributes and provides the profit in an appropriate way.

The business evaluation server 180 receives content business status information from the outside. The business evaluation server 180 generates content business profit sharing information for distributing profit information to each user on the basis of the content business status information and the business evaluation information. The business evaluation server 180 transmits the content business profit sharing information to the user terminal 110 or an application that is operated by a corresponding user account.

The distribution server 190 records and manages business detail information such as content duplication, distribution and reproduction, in the content or in a separate server, with respect to business progress confirmed content. The distribution server 190 conducts business by exposing content duplication, distribution, consumption and reproduction to content consuming subjects through SNS, a shared storage, a web service, or the like.

The distribution server 190 receives block-inserted personal content through the business management server 170 and distributes the block-inserted personal content, or receives generated information from the Blockchain generating engine from the business management server 170, receives the personal content from the data interface server 130, inserts the generated information from the Blockchain generating engine into the personal content, and distributes the block-inserted personal content. The position or method of inserting the Blockchain generation information may be selected in various ways according to various service platforms. The distribution server 190 distributes the block-inserted personal content, and then transmits content distribution reporting information on content distribution to the business management server 170.

The distribution server 190 inserts profit business content such as advertisements into distribution target content according to the business profit model, and then distributes the content. Details of the insertion and distribution are included in the content distribution reporting information.

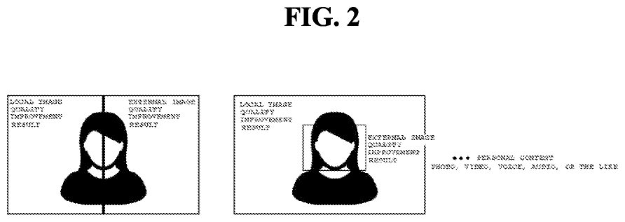

FIG. 2 is a diagram illustrating an example of comparison of a local image quality improvement result and an external image quality improvement result according to an exemplary embodiment of the invention.

As shown in FIG. 2, the user terminal 110 outputs the local image quality improvement result and the external image quality improvement result half and half, or outputs the external image quality improvement result only for a part of an object in an image (for example, a face area) and outputs the local image quality improvement result for the remaining area. Here, the user terminal 110 may adjust internal options so that the external image quality improvement result is not output.

In order to download the external image quality improvement result for the whole area from the image in which the local image quality improvement result and the external image quality improvement result are combined, the user terminal 110 pays for the cost of the external image quality improvement result for the whole area to the cloud server 120, and then downloads the external image quality improvement result for the whole area from the cloud server 120.

As shown in FIG. 2, the user terminal 110 outputs the local image quality improvement result and the external image quality improvement result so that the user can compare them using the loaded application 112. In outputting a screen for comparing the local image quality improvement result with the external image quality improvement result, the user terminal 110 outputs the screen for comparison using various methods such as a left-right comparison method, a top-bottom comparison method, a random area comparison method, a main (external)/sub (internal) area comparison method, and a sequential comparison method.

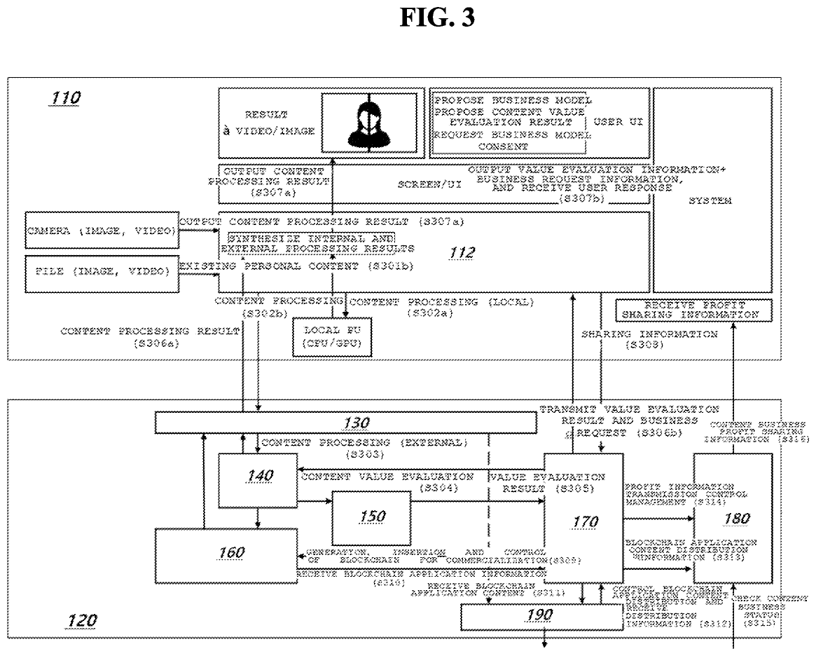

FIG. 3 is a diagram illustrating a method for selling personal content using value evaluation according to an exemplary embodiment of the invention.

The user terminal 110 receives content (image, video) taken from a camera using the loaded application 112 to generate personal content (S301a). The user terminal 110 receives pre-stored content (image, video) using the loaded application 112 to generate personal content (S301b).

The user terminal 110 performs a local image quality improvement process for the content (the content captured from the camera or the pre-stored content) selected using the loaded application 112, using a local CPU or GPU, to generate a local image quality improvement result (S302a). The user terminal 110 transmits the content (the content captured from the camera or the pre-stored content) selected using the loaded application 112 to the data interface server 130 (S302b).

The data interface server 130 transmits the content (the content captured from the camera or the pre-stored content) received from the user terminal 110 to the external image quality improvement engine 140. Here, whether to apply the data interface server 130 may be selected according to a configuration of a service environment, and the personal content may be directly received from the external image quality improvement engine 140 without using the data interface server 130, as necessary.

The external image quality improvement engine 140 performs the external image quality improvement process for the content (the content captured from the camera or the pre-stored content) received from the user terminal 110 using a predetermined image quality improvement algorithm to generate an external image quality improvement result (S303). In step S303, as the predetermined image quality improvement algorithm, an algorithm for performing learning for each different resolution to generate different independent restoration models, and applying a restoration model corresponding to a resolution of a distorted input image among the different independent restoration models to restore the image to an improved image in which a restoration target object in the distorted image is mainly improved may be used, but the present inventive concept is not limited thereto.

The value evaluation engine 150 receives the external image quality improvement result for the content from the external image quality improvement engine 140, and performs value evaluation for the content to generate a value evaluation result (calculation of expected profit and cost for a specific period of time) (S304). In step S304, the value evaluation engine 150 performs value evaluation for the content on the basis of a learning result obtained by learning a business performance result related to at least one of a type, a quality, a subject, and a specification of the content to generate a value evaluation result (calculation of expected profit and cost for a specific period of time).

The business management server 170 receives the value evaluation result for the content from the value evaluation engine 150 (S350).

The external image quality improvement engine 140 transmits the external image quality improvement result for the content (the content captured from the camera or the pre-stored content) received from the user terminal 110 to the user terminal 110 (S306a). The business management server 170 requests a business right (the value evaluation result and business request information) on the basis of the value evaluation result for the content of the user terminal 110 that produced the content or an application that is operated by a user account that produced the content (S306b). In step S306b, the business management server 170 proposes a business request for a specific business (the expected profit and cost for the specific period of time, a profit sharing ratio, and the like), while transmitting the external image quality improvement result and the value evaluation result to the user terminal 110 or the application that is operated by the user account.

The user terminal 110 synthesizes and outputs the local image quality improvement result and the external image quality improvement result (S307a). In step S370a, the user terminal 110 outputs the local image quality improvement result and the external image quality improvement result half and half, or outputs the external image quality improvement result only for a part of an object in an image (for example, a face area) and outputs the local image quality improvement result for the remaining area. Here, the user terminal 110 may adjust internal options so that the external image quality improvement result is not output.

The application 112 included in the user terminal 110 receives the business request (value evaluation result and business request information) for the content for which the external image quality improvement has been performed from the business management server 170. The application 112 included in the user terminal 110 outputs the business request information, and receives a response (consent) to the business request information from the user (S307b).

The application 112 included in the user terminal 110 transmits information on the business response (consent) corresponding to the business request information to the business management server 170 (S308).

In a case where the information on the business response (consent) corresponding to the business request information is received from the user terminal 110, the business management server 170 determines whether or not to proceed with the business right for the content for which the external image quality improvement has been performed. The business management server 170 transmits the content for which the external image quality improvement has been performed for commercialization to the Blockchain generating engine 160. Here, the transmitted information may be the entire content or the minimum information essentially necessary for generating Blockchain information. After generating a business tracking key as a block, the Blockchain generating engine 160 directly inserts the result into the content for which the external image quality improvement has been performed (S310), or transmits the generated information to the business management server 170.

In a case where the entire content is received and the generated block is inserted therein, the Blockchain generating engine 160 transmits the block-inserted content to the business management server 170 or the distribution server 190 (S310). In a case where the block-inserted content is received, the business management server 170 transmits the result to the distribution server 190 (S311) . The distribution server 190 distributes the block-inserted content, and transmits content distribution reporting information about the content distribution to the business management server 170 (S312). The business management server 170 transmits the content distribution reporting information for the block-inserted content received from the distribution server 190 to the business evaluation server 180 (S313).

The business evaluation server 170 calculates profit information on the basis of the content distribution reporting information, and calculates business evaluation information on the basis of the profit information. The business management server 170 controls processing of information generated by the business evaluation server 180 such as the profit information and the business evaluation information for the block-inserted content (S314).

The business evaluation server 180 receives the content distribution reporting information about the content distribution from the business management server 170. The business evaluation server 180 receives content business status information from the outside (S315) . The business evaluation server 180 generates content business profit sharing information for distributing the profit information to each user on the basis of the content business status information and the business evaluation information. The business evaluation server 180 transmits the content business profit sharing information to the user terminal 110 (S316).

In FIG. 3, an example in which steps S301a to S316 are sequentially executed is shown, but the present inventive concept is not limited thereto. In other words, the order of the steps described in FIG. 3 may be changed, or a plurality of the steps may be executed in parallel.

The above-described method for selling personal content using value evaluation according to the present embodiment described with reference to FIG. 3 may be implemented as a program, and may be recorded on a computer-readable recording medium. The computer-readable recording medium on which the program for implementing the method for selling personal content using value evaluation according to the present embodiment includes a variety of recording devices that stores data readable by a computer system.

The above description is merely an example of the technical idea of the present inventive concept, and various modifications and variations can be made to those skilled in the art without departing from the concept of the present inventive concept. Accordingly, the above-described embodiments are not intended to limit the technical idea of the present inventive concept, and the scope of the technical idea of the present inventive concept is not limited by the embodiments. The scope of protection of the present inventive concept should be interpreted according to claims, and all technical ideas equivalent thereto should be interpreted as being included in the scope of the invention.

1. A system for selling personal content using value evaluation, comprising:
a user terminal that performs an internal image quality improvement process for selected personal content to generate a local image quality improvement result, receives an external image quality improvement result for the personal content, compares the local image quality improvement result with the external image quality improvement result for the personal content, and outputs the comparison result; and
a cloud server that receives the personal content, performs an external image quality improvement process for the personal content to generate the external image quality improvement result, transmits the external image quality improvement result to the user terminal, proposes a business right together with a value evaluation result obtained by valuating the personal content for which the external image quality improvement has been performed, distributes the personal content for which the external image quality improvement has been performed in a case where a consent to the business right is made from the user terminal, and shares a profit for the personal content.

2. The system according to claim 1,
wherein the user terminal performs the internal image quality improvement process on the personal content selected using a loaded application on the basis of a local CPU or GPU to generate the local image quality improvement result.

3. The system according to claim 2,
wherein the cloud server shares the profit for the personal content to which a Blockchain is applied, and includes a data interface server, an external image quality improvement engine, a value evaluation engine, a Blockchain generating engine, a business management server, a business evaluation server, and a distribution server,
the data interface server interworks with the user terminal, and transmits the personal content received from the user terminal to the external image quality improvement engine, and
the external image quality improvement engine performs the external image quality improvement process using an algorithm for generating the personal content as an improved image using a pre-learned improvement model to generate the external image quality improvement result.

4. The system according to claim 3,
wherein the user terminal outputs the local image quality improvement result on one side of a screen, outputs the external image quality improvement result on the other side of the screen, and compares the local image quality improvement result with the external image quality improvement result, or
outputs the external image quality improvement result to a partial area of the screen, outputs the local image quality improvement result to the remaining area of the screen, and compares the local image quality improvement result with the external image quality improvement result.

5. The system according to claim 4,
wherein the user terminal outputs, in outputting the screen for comparing the local image quality improvement result with the external image quality improvement result, the screen for comparison in any one of a left-right comparison method, a top-bottom comparison method, a random area comparison method, an external-internal area comparison method, and a sequential comparison method.

6. The system according to claim 5,
wherein, in order to download the entirety of the external image quality improvement result, the user terminal pays for the cost of the external image quality improvement result to the cloud server, and downloads the external image quality improvement result from the cloud server.

7. The system according to claim 6,
wherein the value evaluation engine receives the external image quality improvement result for the personal content from the external image quality improvement engine, and performs value evaluation for the personal content to generate a value evaluation result including expected profit and cost for a specific period of time.

8. The system according to claim 7,
wherein the value evaluation engine performs value evaluation for the personal content on the basis of a learning result obtained by learning a business performance result related to at least one of a type, a quality, a subject, and a specification of the personal content to generate the value evaluation result including the expected profit and cost for the specific period of time, and transmits the value evaluation result for the personal content to the business management server.

9. The system according to claim 8,
wherein the business management server proposes a business right request including the expected profit and cost for the specific period of time and a profit sharing ratio for the personal content, while transmitting the external image quality improvement result for the personal content and the value evaluation result to the user terminal that produced the content or an application that is operated by a corresponding user account.

10. The system according to claim 9,
wherein the user terminal outputs the business right request received from the business management server using the installed application, receives a user's consent corresponding to the business right request, and transmits the consent to the business management server.

11. The system according to claim 10,
wherein the business management server determines whether to proceed with the business right for the personal content for which the external image quality improvement has been performed in accordance with the consent corresponding to the business right request received from the user terminal, and transmits a Blockchain information generating control signal to the Blockchain generating engine.

12. The system according to claim 11,
wherein the Blockchain generating engine receives, after receiving the Blockchain information generating control signal for the personal content for which the external image quality improvement has been performed from the business management server, all or part of the personal content from the external image quality improvement engine to generate a business tracking key as a block, and transmits the result to the business management server.

13. The system according to claim 12,
wherein the distribution server simultaneously receives Blockchain generating information through the business management server and the personal content through the data interface server, inserts the Blockchain generating information into the personal content, distributes the block-inserted personal content, and transmits content distribution reporting information on content distribution to the business management server.

14. The system according to claim 13,
wherein the business management server transmits the content distribution reporting information for the block-inserted personal content received from the distribution server to the business evaluation server, and the business evaluation server controls processing and transmission of profit information calculated on the basis of the content distribution reporting information and business evaluation information calculated on the basis of the profit information.

15. The system according to claim 14,
wherein the business evaluation server receives content business status information from the outside, generates content business profit sharing information for distributing the profit information to each user on the basis of the content business status information and the business evaluation information, and transmits the content business profit sharing information to the user terminal.

16. A method for selling personal content using value evaluation, comprising:
performing an internal image quality improvement process for selected personal content to generate a local image quality improvement result, by a user terminal;
receiving the personal content, performing an external image quality improvement process to generate an external image quality improvement result, and transmitting the result to the user terminal, by a cloud server;
receiving the external image quality improvement result for the personal content, by the user terminal;
comparing the local image quality improvement result with the external image quality improvement result for the personal content, and outputting the comparison result, by the user terminal;
proposing a business right together with a value evaluation result obtained by performing value evaluation for the personal content for which the external image quality improvement has been performed, by the cloud server;
distributing the personal content for which the external image quality improvement has been performed in a case where a consent to the business right is made from the user terminal, by the cloud server; and
sharing a profit for the personal content, by the cloud server.
